(19) United States
(12) Patent Application Publication
(10) Pub. No.: US 2012/0117593 A1
(43) Pub. Date: May 10, 2012

(54) System and Method of Delivering Advertisements to a Mobile Communication Device

(76) Inventor: Yang Pan, (US)

(21) Appl. No.: 12/941,998

(22) Filed: Nov. 8, 2010

(51) Int. Cl. H04N 7/025

(52) U.S. Cl. 725/34; 725/32

(57) ABSTRACT

System and method of delivering advertisements to a mobile computing and communication device is disclosed. The system comprises a digital television system and a mobile communication device. A video program being played by the television system may be transferred to the mobile device when a user intends to move away from the television system. According to one embodiment, an advertising message may be delivered on a display of the mobile device when the digital content of the video program is being transmitted. According to another embodiment, advertising messages may be inserted into predetermined positions of the received video program. The advertising messages may be selected based on the user's identity of the mobile device.

### CROSS-REFERENCE TO RELATED APPLICATIONS

Not applicable.

### BACKGROUND

1. Field of Invention

This invention relates generally to advertising. More specifically, the invention relates to system and method for delivering advertising messages using mobile computing and communication devices.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone and iPad from Apple Inc, Cupertino, Calif., to access the Internet services. Methods for delivering targeted advertisements to users by employing mobile devices have been developed. The targeted advertising messages may be delivered based upon the user's personal profile, location and history of the user's interaction with the device.

### SUMMARY OF THE INVENTION

It is an object of the present invention to propose a method of delivering an advertising message to a user of a mobile device when the device is connected to a digital television (TV) system while digital content of a video program is being downloaded.

It is another object of the present invention to propose a method of delivering advertising messages to a user of a mobile device by inserting personalized advertising messages into a digital video program downloaded from the digital TV system.

It is yet a further object of the present invention to combine the above mentioned two methods of the advertising message delivery.

In an exemplary implementation, the digital TV system and the mobile device may be connectable through a communication link such as an ad hoc communication link like a Bluetooth type of connection.

According to one embodiment, a video program is being played by the digital TV system. After an input structure of a remote control device is actuated by the user, digital content of the video program is transmitted from the digital TV system to the mobile device through the communication link. An advertising message may be delivered to a display of the mobile device while the digital content is being transmitted. The advertising message may be transmitted from the digital TV system. The advertising message may also be transmitted from an advertiser to the mobile device through a communication network. The advertising messages may even be pre-stored in the mobile device.

According to another embodiment, advertising messages are inserted into predetermined positions of the received digital content of the video program. The advertising messages may be delivered when the received video program is being played using the mobile device. The advertising messages may be selected based on the identity of the user of the mobile device.

According to yet another embodiment, the above two methods for delivering advertising messages may be combined.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an advertising message delivery system based on a digital TV system and a mobile device in accordance with one embodiment;

FIG. 2 is a schematic diagram of functional blocks of the digital TV system in accordance with one implementation;

FIG. 3 is a schematic diagram of functional blocks of the mobile device in accordance with one implementation;

FIG. 4A is a schematic diagram illustrating exemplarily an advertising message is displayed on a display of the mobile device while the digital content of a video program is being transmitted from the digital TV system to the mobile device;

FIG. 4B is a schematic diagram illustrating exemplarily received video program is being played using the mobile device, where the personalized advertising messages are inserted into the video program;

FIG. 5A is a schematic diagram of functional blocks and data flows of the system in accordance with one embodiment that the advertising messages are transmitted from the digital TV system to the mobile device;

FIG. 5B is a schematic diagram of functional blocks and data flows of the system in accordance with another embodiment that the advertising messages are delivered from an advertiser to the mobile device through a communication network;

FIG. 6 is a flowchart illustrating an exemplary process that an advertising message is displayed on a mobile device while a video program is transmitted from the digital TV system to the mobile device;

FIG. 7 is a flowchart illustrating an exemplary process that advertising messages are delivered to the user of the mobile device by inserting them into the received video program.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

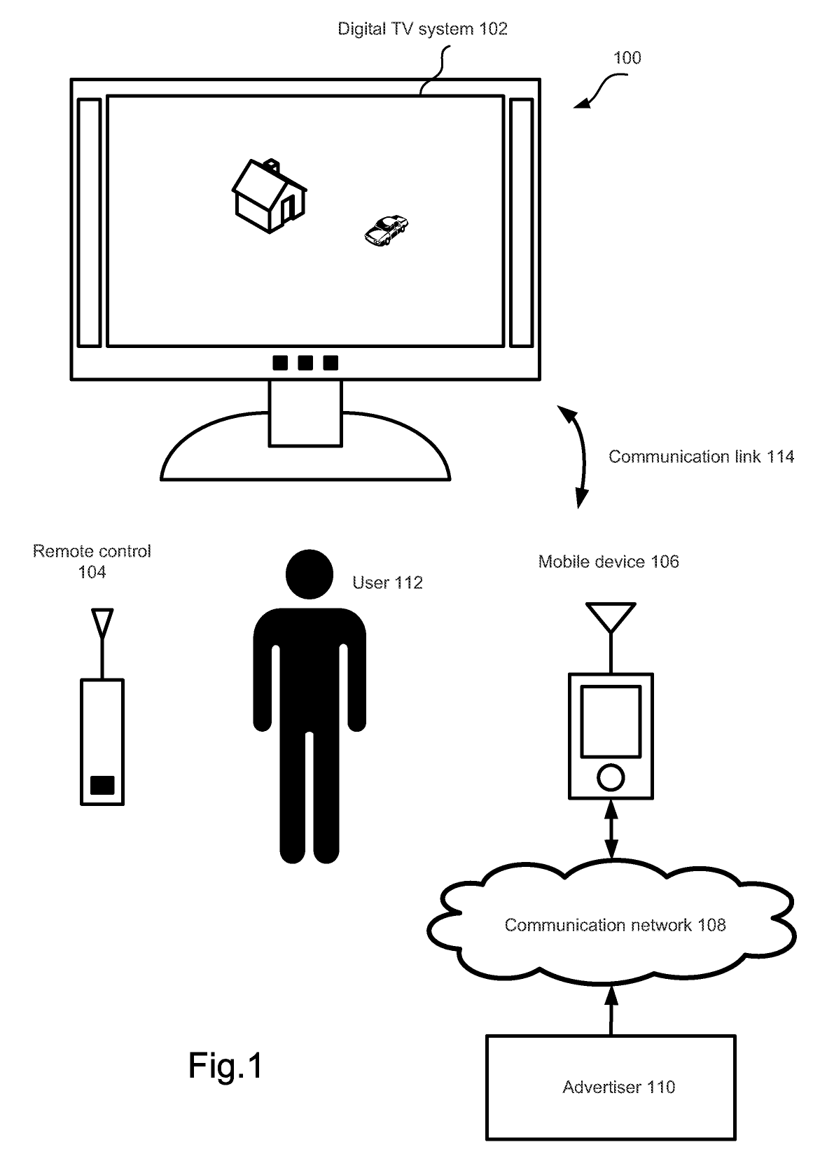

FIG. 1 is a schematic diagram illustrating an advertisement delivery system according to one embodiment. The system 100 comprises a digital TV system 102 with a remote control device 104. According to one implementation, the remote control device 104 may include an input structure for controlling of transmitting digital content of a video program from the digital TV system 102 and a mobile computing and communication device 106. According to another implementation, the mobile device 106 may include an input structure for controlling the transmission. The mobile device 106 may be a mobile phone with the Internet connection capability. The mobile device 106 may also be a tablet computer. The mobile device 106 may even be a portable media player. The mobile device 106 is connectable to an advertiser 110 through a communication network 108. The digital TV system 102 may also be connected to the advertiser 110 through the communication network 108 (not shown in FIG. 1). A user 112 operates the system. The remote control device 104 and the digital TV system 102 are connected employing one of well known methods such as, for example, using the Infrared communication interface. The digital TV system 102 and the mobile device 106 may be connected using a communication link 114. The communication link 114 may be an ad hoc communication link in an exemplary case. The communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC).

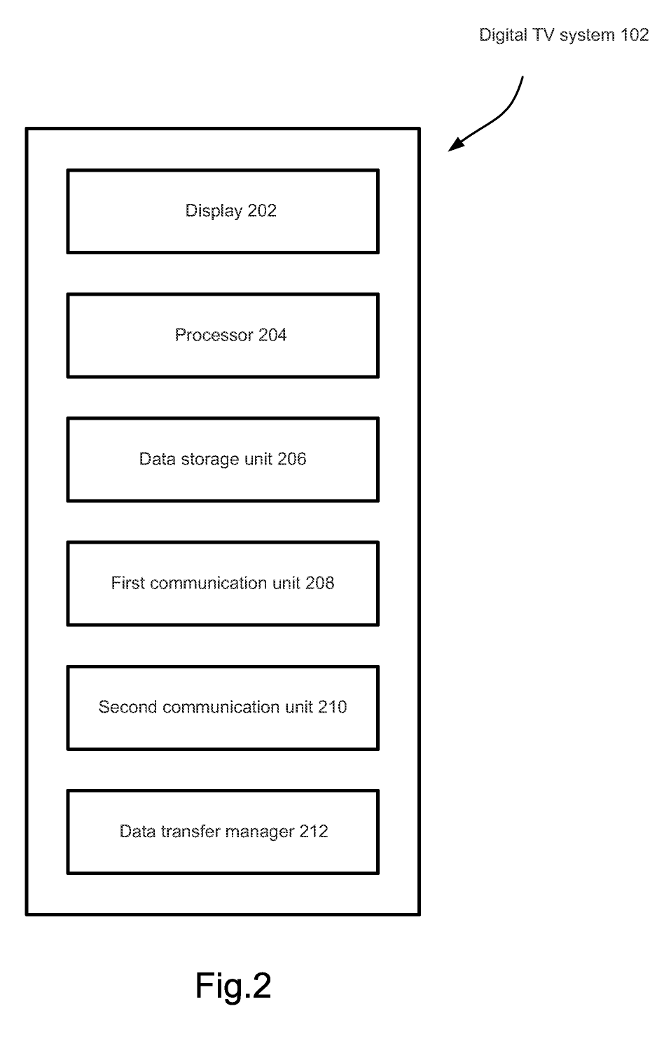

FIG. 2 is a schematic representation of functional blocks of the digital TV system 102 in according with one embodiment. The system 102 comprises a display 202. The display may be a Liquid Crystal Display (LCD). The display may also be any other type of displays as known in the art. A processor 204 is used to control the operation of the digital TV system 102. The processor 204 may include more than one type of processors such as a general purpose processor and a special purpose processor. The system 102 may also include a data storage unit 206 such as a magnetic storage unit and/or semiconductor memory devices.

The digital TV system 102 may be connected to a communication network through a first communication unit 208. The network may be a private broadband network for delivering TV programs. The network may also be a public network such as, for example, the Internet. A second communication unit 210 is used to connect the digital TV system 102 to the mobile device 106 through the communication link 114. The communication link 114 may be conformed to various IEEE and ISO standards and their extensions such as, for example, IEEE 802.15.1 (Bluetooth), IEEE 802.15.4 (ZigBee), IEEE 802.11x (WiFi) and ISO 18092, ISO 21481 and Transfer Jet Protocol for Near Field Communication (NFC). The digital TV system 102 may also include a third communication unit (not shown in the figure) for connecting the system and the remote control device 104. Most remote control devices today use Infrared communication interfaces.

A data transfer manager 212 is used to control data transfer from the digital TV system 102 to the mobile device 106. The data transfer manager 212 may be implemented as software. The data manager 212 may also be implemented as a combination of the software and the hardware.

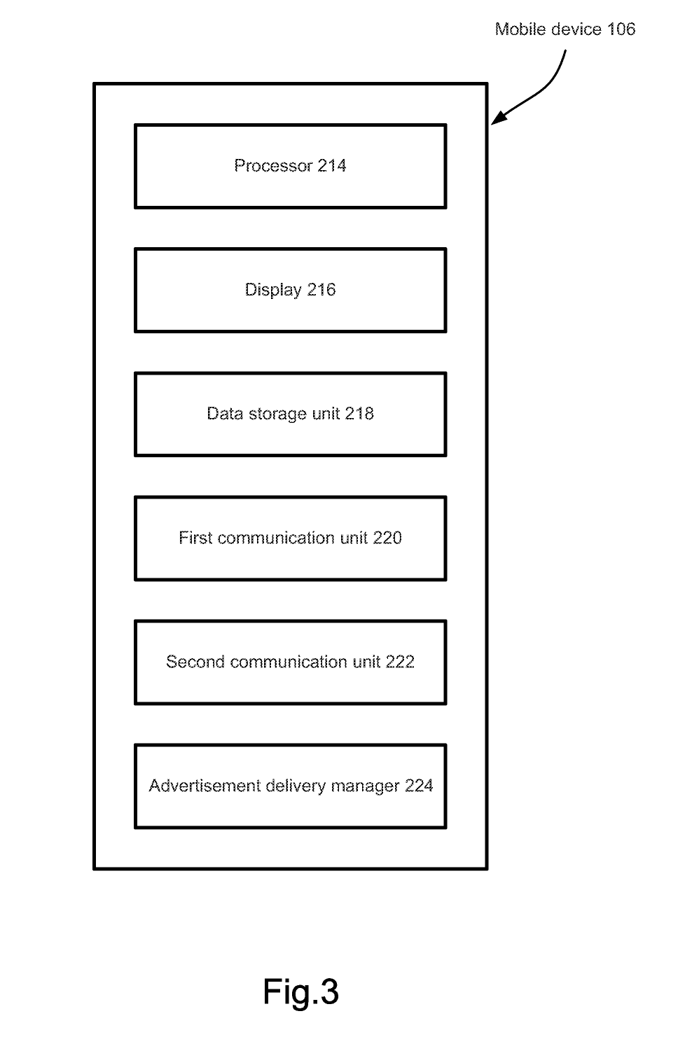

FIG. 3 is a schematic representation of functional blocks of the mobile device 106. The device 106 comprises a processor 214, a display 216 and a data storage unit 218. The display 216 may be a touch-sensitive type of display. The mobile device 106 includes a first communication unit 220. The first communication unit 220 may be a standard network interface for a smart phone including a capability to connect to the Internet. The device 106 further comprises a second communication unit 222 for connecting to the digital TV system 102 through the previously mentioned communication link 114. The communication unit 222 in the mobile device 106 and the communication unit 210 in the digital TV system 102 may be conformed to the same communication standard(s).

An advertisement delivery manager 224 is used to control operations of delivering advertising messages using the mobile device 106. The advertising messages may be sent from the digital TV system 102. The advertising messages may be transmitted from an advertiser 110 to the mobile device 106 through the communication network 108. The advertising message may also be pre-stored in the mobile device 106. The advertising messages may be tailored to the personal profile of the user 110.

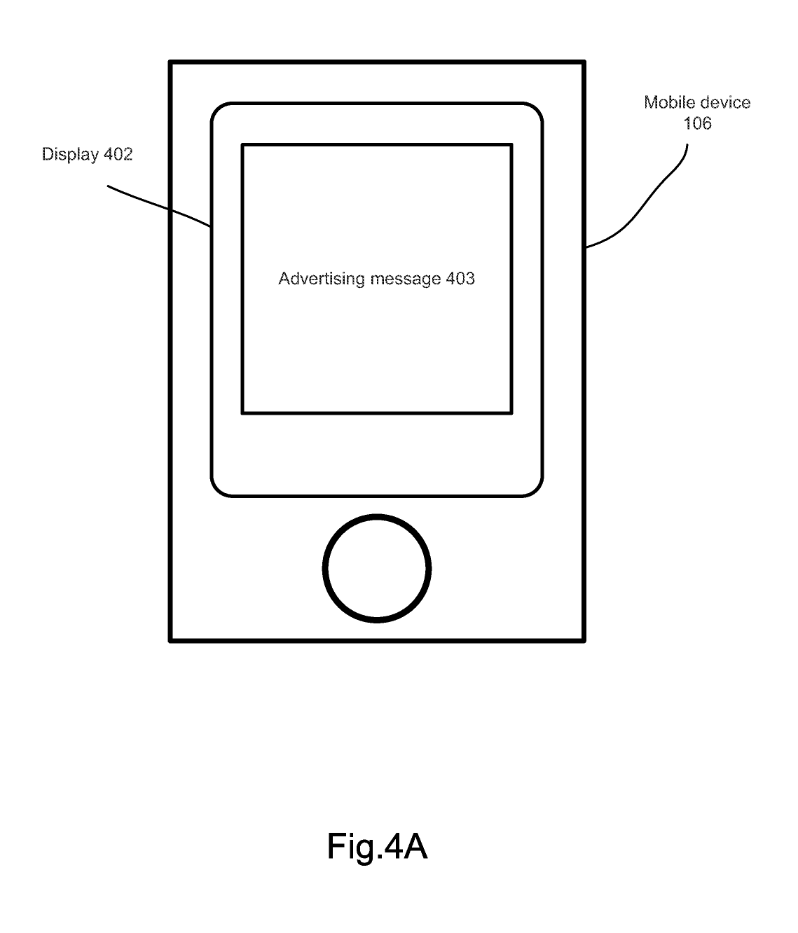

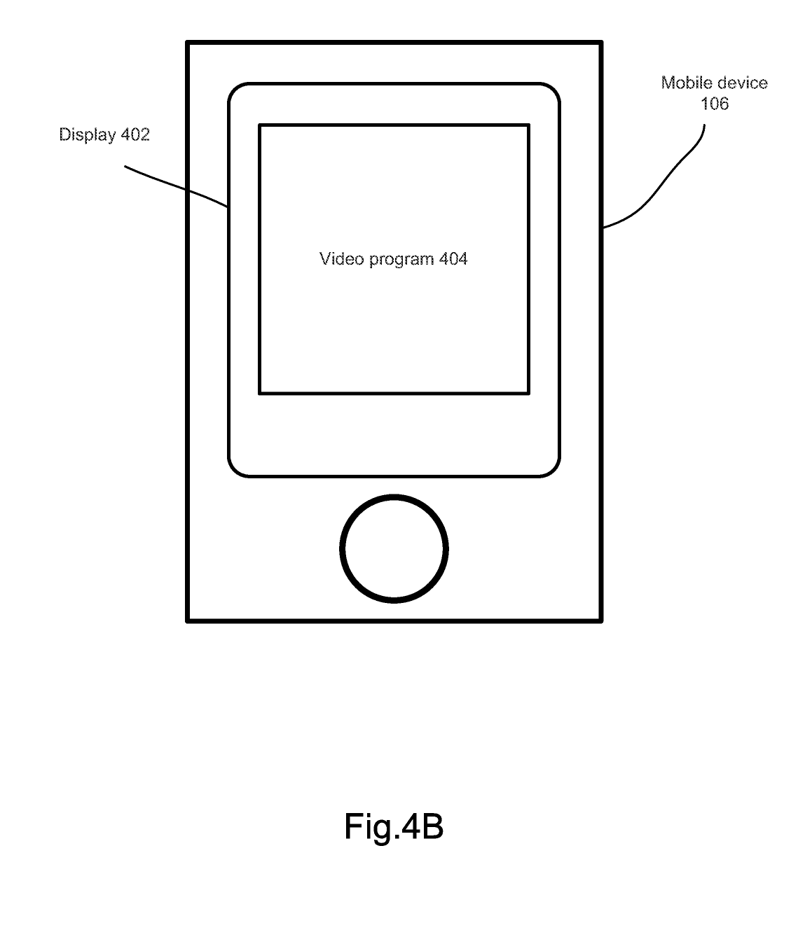

FIG. 4A is a schematic diagram illustrating exemplarily an advertising message 403 is displayed on a display 402 of the mobile device 106 while the digital content of a video program is being transmitted from the digital TV system 102 to the mobile device 106. The advertising message 403 may be a text message, an image, a web page and a video program. The advertising message 403 may also be a voice message. The voice message maybe delivered in accompanying with an image displayed on the mobile device 106. More than one advertising message may be displayed while the digital content is being transmitted from the digital TV 102 to the mobile device 106.

FIG. 4B is a schematic diagram illustrating exemplarily that a received video program 404 is being played using mobile device 106. Advertising messages may be inserted into predetermined positions of the video program 404. When the received video program 404 is played using the mobile device 106, the advertising messages may be delivered in a similar manner as delivered using a TV system. The advertising messages may be tailored to the personal profile of the user. It is easier to identify a user when a mobile device 106 is used. The video program 404 may be a completed program. The video program may also be a portion of a completed program. A user may need to walk away from a TV program. The mobile device 106 may be used as a portable TV system to complete the playing of the program. The advertising messages may be programmed into the video program in a personalized manner.

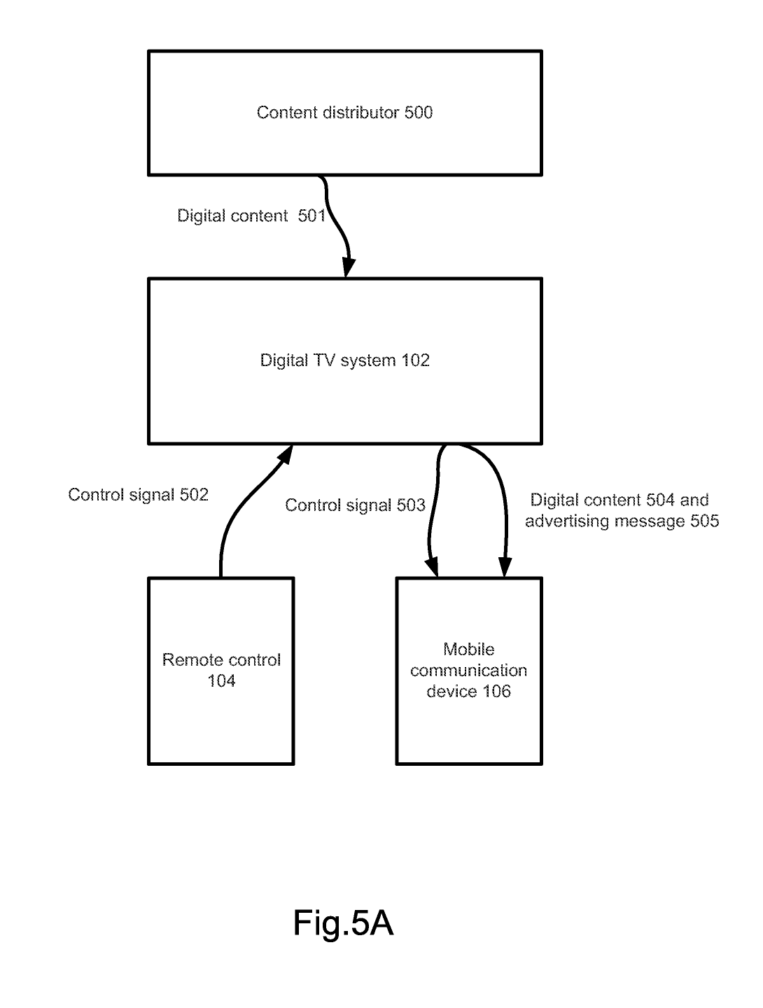

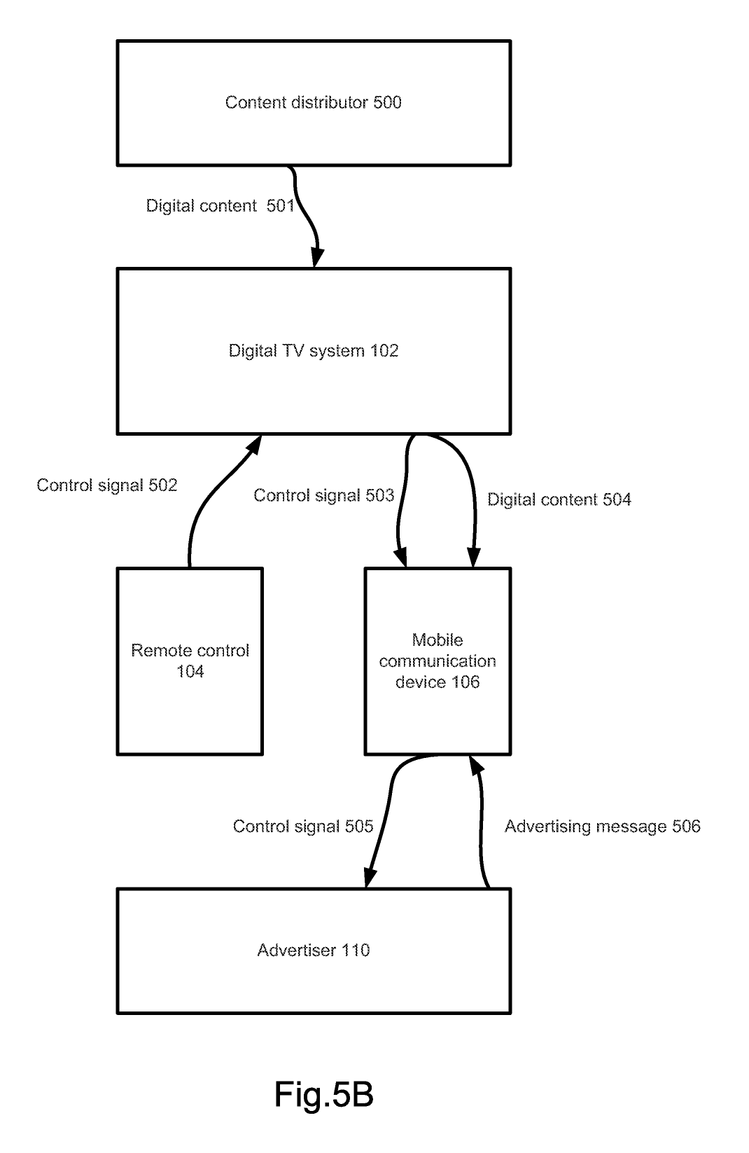

FIG. 5A is a schematic diagram of functional blocks and data flows of the system 100 in accordance with one embodiment. When the digital TV system 102 is used to play a video program, the digital content 501 may be delivered from a content distributor 500. A control signal 502 is sent from the remote control device 104 to the digital TV system 102 after the user actuates the remote control device 104. Upon receiving the control signal 502, the digital TV system 102 sends another control signal 503 to the mobile device 106. A data file including digital content 504 and advertising message 505 is sent to the mobile device 106 according to one embodiment of the present invention.

FIG. 5B is a schematic diagram of functional blocks and data flows of the system 100 in accordance with another embodiment. When the digital TV system 102 is used to play a video program, the digital content 501 may be delivered from a content distributor 500. A control signal 502 is sent from the remote control device 104 to the digital TV system 102 after the user actuates the remote control device 104. Upon receiving the control signal 502, the digital TV system 102 sends another control signal 503 to the mobile device 106. A data file including digital content 504 is sent to the mobile device 106. Upon receiving the digital content 504, another control signal 505 is sent from the mobile device 106 to the advertiser 110. The advertiser 110 sends advertising message 506 to the mobile device 106. The advertisement manager 224 in the mobile device 106 inserts the received advertising messages into the received digital content 504 of the video program. The advertising messages may be tailored to the personal profile of the user.

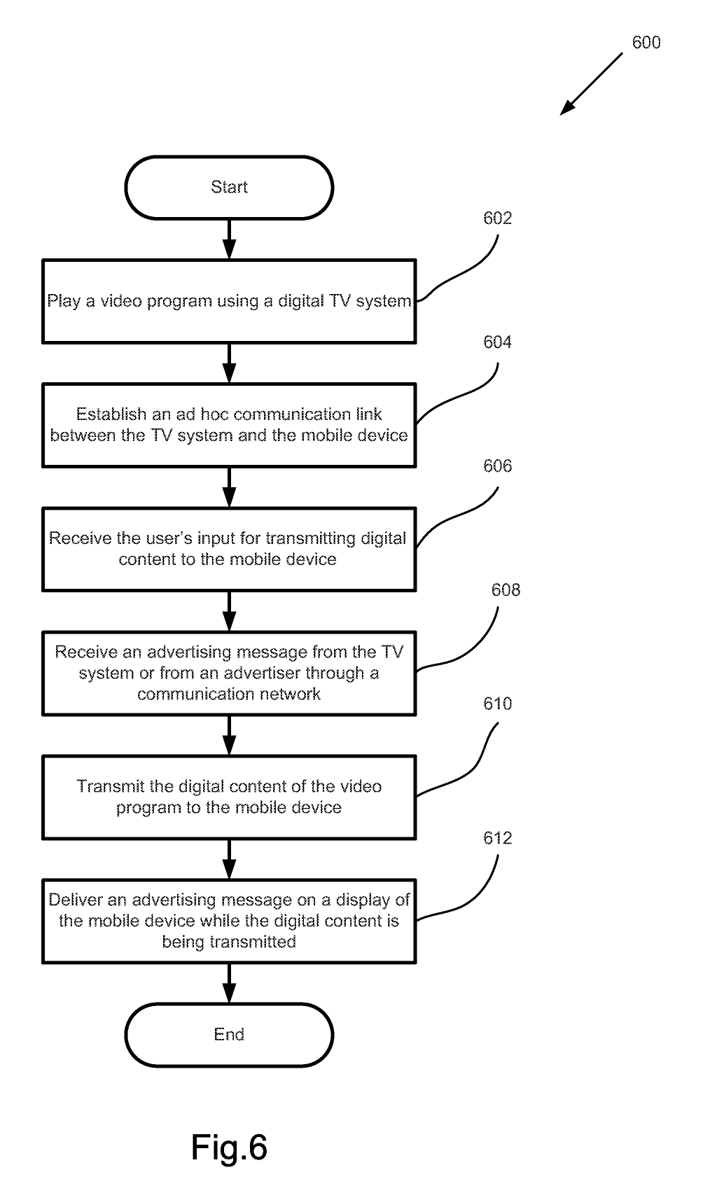

FIG. 6 is a flowchart illustrating an exemplary process 600 that an advertising message is delivered using a mobile device 106 while a video program is being transmitted from the digital TV system 102. Process 600 starts with step 602 that a video program is being played by the digital TV system 102. In step 604, an ad hoc communication link 114 is established between the mobile device 106 and the digital TV system 102. In an exemplary implementation, the ad hoc communication link 114 is a Bluetooth type of connection. In step 606, a user's input for transmitting the digital content of the video program from the digital TV 102 to the mobile device 106 is received. The user may actuate an input structure of the remote control device 104. The user may also actuate an input structure of the mobile device 106. In step 608, advertising messages are received by the mobile device 106. The advertising messages may be delivered from the digital TV system 102. The advertising messages may also be delivered from the advertiser 110 through the communication network 108. In step 610, the digital content of the video program is sent from the digital TV to the mobile device 106. The advertising messages are displayed in step 612 while the digital content is being transmitted.

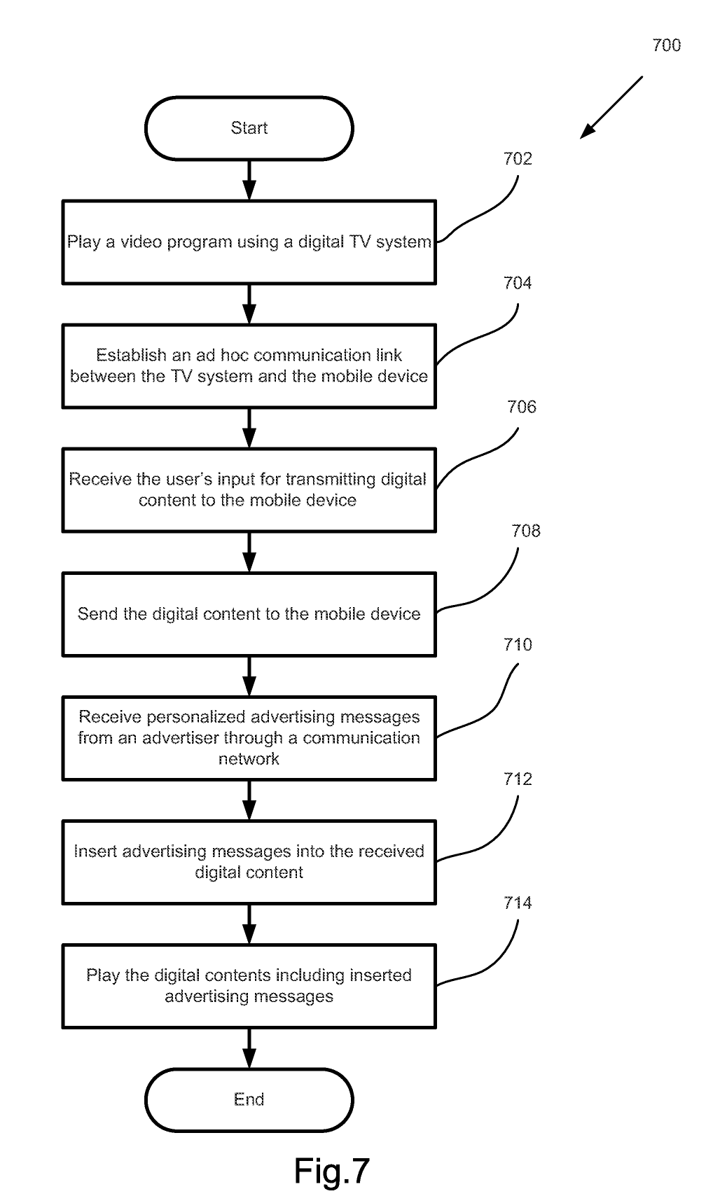

FIG. 7 is a flowchart illustrating an exemplary process 700 that advertising messages are inserted into predetermined positions of the received video program. Process 700 starts with step 702 that a video program is being played by the digital TV system 102. In step 704, an ad hoc communication link 114 is established between the mobile device 106 and the digital TV system 102. In an exemplary implementation, the ad hoc communication link 114 is a Bluetooth type of connection. In step 706, a user's input for transmitting the digital content of the video program from the digital TV 102 to the mobile device 106 is received. The user may actuate an input structure of the remote control device 104. The user may also actuate an input structure of the mobile device 106. In step 708, the digital content of the video program is sent from the digital TV to the mobile device 106. In step 710, advertising messages are received by the mobile device 106. The advertising messages may be sent from the digital TV system 102. The advertising messages may also be sent from the advertiser 110 through the communication network 108. In step 712, the advertising messages are inserted into the received video program in predetermined positions. The advertising messages may be tailored based on personal profile of the user. In step 714, the video program is played including the inserted advertisements.

It should be noted that there is yet another embodiment base on the present invention. The advertising message is delivered using the mobile device 106 while the digital content of the video program is being transmitted from the digital TV system 102. After receiving the digital content of the video program, advertising messages are inserted into the received video program. The advertising messages are delivered while the received video program is being played. The advertising messages may be tailored to the personal profile of the user of the mobile device 106. According to the embodiment, the advertising messages are delivered when the digital content is being transmitted and also when the received digital content is played.

While the invention has been disclosed with respect to a limited number of embodiments, numerous modifications and variations will be appreciated by those skilled in the art. It is intended that all such variations and modifications fall within the scope of the following claims:

1. A method of delivering an advertising message comprising:
connecting a digital television system and a mobile computing and communication device through a communication link;
transmitting at least a portion of digital content of a video program, being played by the digital television system, to the mobile device; and
delivering at least one advertising message on a display of the mobile device while the digital content is being transmitted.

2. The method as recited in claim 1, wherein said method further comprising:
actuating an input structure of a remote control device or of the mobile device to trigger said operation of transmitting said digital content.

3. The method as recited in claim 1, wherein said method further comprising transmitting advertising messages from the digital television system to the mobile devices prior to said step of transmitting said digital content.

4. The method as recited in claim 1, wherein said method further comprising transmitting the advertising messages from an advertiser to the mobile device through a communication network including the Internet.

5. The method as recited in claim 1, wherein said advertising messages may be pre-stored in a storage unit of the mobile device.

6. The method as recited in claim 1, wherein said advertising message further comprising:
a video clip;
a text message;
an image;
a voice message; and
a web page.

7. The method as recited in claim 1, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

8. A method of delivering an advertising message comprising:
connecting a digital television system and a mobile computing and communication device through a communication link;
transmitting at least a portion of digital content of a video program being played by the digital television system to the mobile device;
inserting personalized advertising messages into predetermined positions of the received digital content of the video program; and
delivering the received video program and the advertising messages using the mobile device.

9. The method as recited in claim 8, wherein said advertising messages are selected based on the identity of at least one of the users of the mobile device.

10. The method as recited in claim 8, wherein said method further comprising:
actuating an input structure of a remote control device or of the mobile device to trigger the said operation of transmitting the digital content.

11. The method as recited in claim 8, wherein said method further comprising transmitting advertising messages from the digital television system to the mobile devices prior to said step of transmitting said digital content.

12. The method as recited in claim 8, wherein said method further comprising transmitting the advertising messages from an advertiser to the mobile device through a communication network including the Internet.

13. The method as recited in claim 8, wherein said advertising messages may be pre-stored in a storage unit of the mobile device.

14. The method as recited in claim 8, wherein said advertising message comprising:
a video clip;
a text message;
an image;
a voice message; and
a web page.

15. The method as recited in claim 8, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).

16. A method of delivering an advertising message comprising:
connecting a digital television system and a mobile computing and communication device through a communication link;
transmitting at least a portion of digital content of a video program being played by the digital television system to the mobile device;
delivering a first group of advertising messages on a display of the mobile device while the digital content is being transmitted;
inserting a second group of advertising messages into predetermined positions of the received digital content of the video program; and
playing the video program and the second group of advertising messages using the mobile device.

17. The method as recited in claim 16, wherein said first and said second groups of the advertising messages are selected based on the identity of at least one of the users of the mobile device.

18. The method as recited in claim 16, wherein said method further comprising transmitting the advertising messages from the digital television system to the mobile devices prior to said step of transmitting said digital content.

19. The method as recited in claim 16, wherein said method further comprising transmitting the advertising messages from an advertiser to the mobile device through a communication network including the Internet.

20. The method as recited in claim 16, wherein said communication link conforming to one of or a combination of the following standards:
Bluetooth (IEEE 802.15.1 and its extensions);
ZigBee (IEEE 802.15.4 and its extensions);
WiFi (IEEE 802.11x and its extensions); and
NFC (ISO 18092; or ISO 21481).
